(19) United States
(12) Patent Application Publication
(10) Pub. No.: US 2006/0047874 A1
(43) Pub. Date: Mar. 2, 2006

(54) Resource management apparatus

(76) Inventors: Yoshiharu Watanabe, Kyoto (JP); Yuji Takai, Osaka (JP); Isao Kawamoto, Hyogo (JP); Takahide Baba, Hyogo (JP); Daisuke Murakami, Kyoto (JP); Toshihiro Fukuyama, Osaka (JP)

Correspondence Address: MCDERMOTT WILL & EMERY LLP, 600 13TH STREET, N.W., WASHINGTON, DC, 20005-3096, US

(21) Appl. No.: 11/197,302

(22) Filed: Aug. 5, 2005

(30) Foreign Application Priority Data
Aug. 30, 2004 (JP) 2004-249793
Jun. 29, 2005 (JP) 2005-190006

(51) Int. Cl. G06F 13/14

(52) U.S. Cl. 710/244

(57) ABSTRACT

To manage accesses from a plurality of masters to a shared resource, a plurality of command registers of each holding an access command received from any of the masters and a plurality of address registers of each holding a register number identifying a command register holding a valid access command, are provided. To rearrange the issuing order of access commands, register numbers held in the address registers are rearranged.

### BACKGROUND OF THE INVENTION

The present invention relates to a resource management apparatus for managing access from a plurality of masters to a shared resource, and more particularly, to a technique to control the issuing order of commands to access a shared resource.

A buffer memory such that first input data can be retrieved first, i.e., FIFO (first-in first-out) is widely known. When stored data are assigned respective priority levels, the data may be retrieved in order of priority, highest first. This data structure is called priority queue. For the priority queue, various techniques are already known.

According to a certain conventional technique, in a disk apparatus which is shared by a plurality of computing machines, the processing order of access requests from the computing machines is controlled, depending on the urgency. To achieve this, a priority table which defines priority for each address space is prepared. When there are some preceding access requests in a queue, an access request which newly arrives at the disk apparatus can overtake the preceding access requests having a priority level lower than that of the new access request (Japanese Unexamined Patent Publication No. 2001-222382).

According to another conventional technique, in an apparatus having an optical disc autochanger, an intermediate queue file is provided in addition to a request queue file. The request queue file stores access requests which designate disc names, in order of input. At a certain time point, access requests accumulated in the request queue file are rearranged, and the result is stored in the intermediate queue file. In this case, in order to reduce frequent disc change operations, the access requests are rearranged so that an access request to a currently reproduced disc is assigned the highest priority and access requests to the same disc are arranged continuously. The autochanger is driven in accordance with the contents of the intermediate queue file (Japanese Unexamined Patent Publication No. H05-61805).

According to still another conventional technique, in a data processing system, a shared buffer is provided between a plurality of processors and a main memory. Each processor sends a memory reference request to the shared buffer. The memory reference request contains a memory reference address, an identifier for a processor, the type of the memory reference request, and a number indicating the ordinal level of processing a command. The memory reference request is placed in a queue. When an access to the shared buffer has no hit, the main memory is accessed. Note that it takes a long time to access the main memory. Therefore, when a certain memory reference request is waiting in a queue for transfer of required data from the main memory, a following memory reference request is processed without waiting, i.e., an overtaking process allows access to the shared buffer. In addition, the overtaking process is allowed with respect to memory reference requests sent from the same processor while guaranteeing a predetermined order of memory reference (Japanese Unexamined Patent Publication No. H06-214875).

According to still another conventional technique, in an ATM (asynchronous transfer mode) communication, cells to be transmitted are successively stored in a random access memory, memory addresses of the cells are held separately, and the cells are transmitted to a transmission path on a first come, first priority basis. Note that, when a specific cell among cells waiting for transmission in the memory needs to be transmitted with priority, the priority cell is read out from the memory by referencing the held memory address and is transmitted to the transmission path (Japanese Unexamined Patent Publication No. H11-331197).

According to still another conventional technique, in a communication node of a LAN (local area network) and a multiprogramming processor, a stack memory for holding a plurality of queue elements and a register for holding a queue element having the highest priority are provided. Each queue element is data or an address designating data. After the queue element having the highest priority is read out from the register, a search operation accompanied with a swapping operation between the register and the stack memory is executed, whereby a queue element having the next highest priority is held in the register. Thereafter, when a new element to be written into a queue arrives, the priority of the new element is compared with the priority of the queue element stored in the register. When the priority of the new queue element is higher than that of the queue element held in the register, the queue element held in the register is written into the stack memory and the new queue element is written into the register in place of the queue element previously held in the register. On the other hand, when the priority of the queue element held in the register is higher, the new queue element is written into the stack memory. As a result, it is guaranteed that the register always contains a queue element having the highest priority, thereby achieving the priority queue function (U.S. Pat. No. 4,965,716).

In a system in which a plurality of masters access a shared resource, a resource management apparatus manages accesses to the shared resource. In this case, the resource management apparatus receives an access command from each master, which contains information for identifying the master which issues the access command. Each access command also contains a memory address when the shared resource is a memory, or an I/O (input/output) port address when the shared resource is a peripheral I/O controller. Therefore, each access command typically has a large bit length. Particularly when the memory has a large volume, the size of an access command may reach, for example, 40 bits.

When a command queue which operates as a priority queue is provided in the resource management apparatus having such a background, swapping of large size data occurs if access commands themselves are tried to be rearranged in the command queue. In this case, however, power consumption is large. This problem is becoming significant, particularly for mobile terminals which require low power consumption. In addition, the data swapping requires a large circuit-scale hardware structure.

### SUMMARY OF THE INVENTION

An object of the present invention is to provide an optimum internal structure of a resource management apparatus having a command queue which operates as a priority queue.

Another object of the present invention is to reduce the power consumption and circuit scale of a command queue which operates as a priority queue.

To achieve these objects, the present invention provides a resource management apparatus for use in a system in which a plurality of masters access a shared resource. The resource management apparatus comprises an access request arbitration section, a command queue, and a resource control section. The access request arbitration section arbitrates access conflict, depending on access requests from a plurality of masters. The command queue successively receives and holds an access command issued from any one of the plurality of masters which is permitted by the access request arbitration section to access, and issues one of access commands waiting for issuance every time command issuance is requested. The resource control section gives a command issuance request to the command queue and receives an access command issued from the command queue, and in accordance with the received access command, controls data transfer between one of the plurality of masters and the shared resource.

The command queue of the present invention comprises a plurality of first storage elements of each holding an access command received from any of the plurality of masters, a plurality of second storage elements of each holding an address identifying one holding a valid access command of the plurality of first storage elements, a command write control section of performing a control so that a newly received access command is held in an empty one of the plurality of first storage elements, a command overtaking condition determination section of controlling an order of addresses held in the plurality of second storage elements in accordance with predetermined command overtaking conditions so that all addresses including an address identifying one holding the newly received access command of the plurality of first storage elements and an address identifying one holding a preceding access command of the plurality of first storage elements are arranged in order of command issuance, and control means of performing a control so that an access command is read out from one identified with a leading address in the plurality of second storage elements of the plurality of first storage elements, and the read access command is supplied to the resource control section.

The plurality of first storage elements can be composed of a small-volume memory, a set of registers, or the like. The same is true of the plurality of second storage elements. In addition, an address (a memory cell location, a register number, etc.) held in each of the plurality of second storage elements can be caused to be small as compared to an access command itself held in each of the plurality of first storage elements.

According to the present invention, the access request arbitration section, the command queue operating as a priority queue, and the resource control section constitute the resource management apparatus. Therefore, only an access command issued from a master which is permitted by arbitration to access can be successively supplied to the command queue, and the command queue can be caused to issue an access command having the highest priority every time the shared resource becomes accessible. In addition, by rearranging addresses whose size is smaller than that of an access command itself in the command queue, the issuing order of access commands can be controlled. Therefore, the power consumption and circuit scale of the command queue can be reduced.

### BRIEF DESCRIPTION OF THE DRAWINGS

FIG. 1 is a block diagram illustrating a schematic example of a structure of a resource management apparatus according to the present invention.

FIG. 2 is a conceptual diagram illustrating an exemplary format of an access command given to a command queue in FIG. 1.

FIG. 3 is a block diagram illustrating an example of a detailed structure of the command queue of FIG. 1.

FIG. 4 is a flowchart illustrating an exemplary operation of a command write control section and a command overtaking condition determination section in FIG. 2.

FIG. 5 is a flowchart illustrating another exemplary operation of the command write control section and the command overtaking condition determination section of FIG. 2.

### DESCRIPTION OF THE PREFERRED EMBODIMENTS

Hereinafter, embodiments of the present invention will be described with reference to the accompanying drawings.

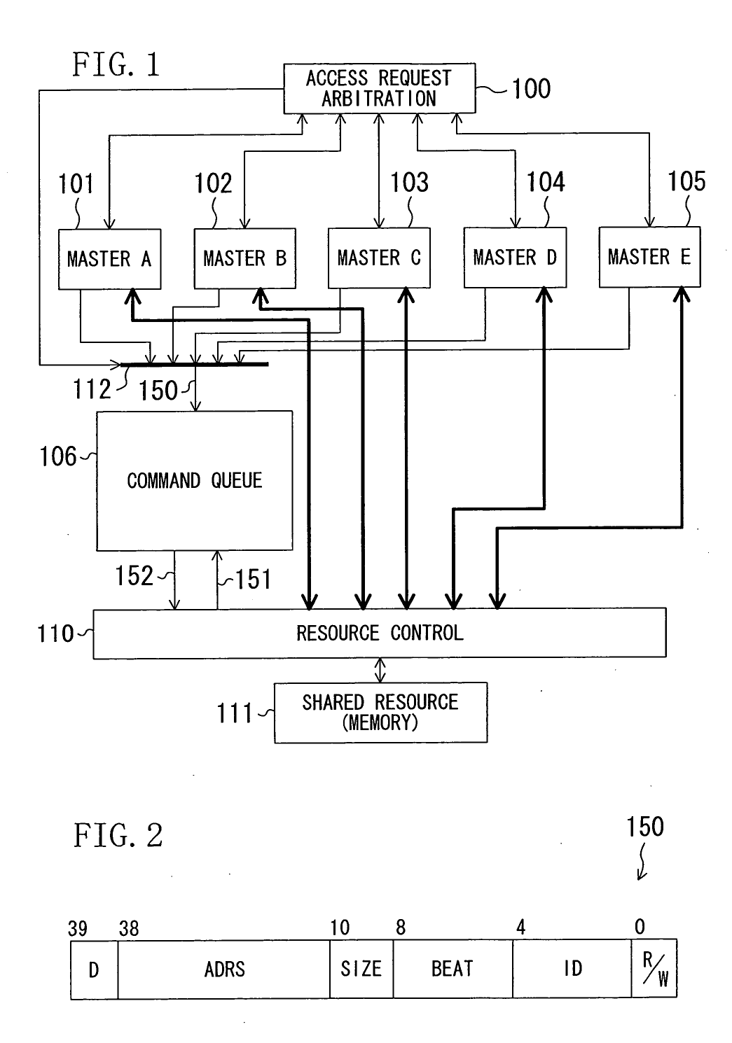

FIG. 1 illustrates a schematic example of a structure of a resource management apparatus according to the present invention. In FIG. 1, a resource management apparatus in a data processing system in which five masters (A to E) 101, 102, 103, 104, 105 access a shared resource 111 is illustrated. The resource management apparatus comprises an access request arbitration section 100, a command queue 106, and a resource control section 110. Further, a queue input selector 112 is provided between the masters 101 to 105 and the command queue 106. Each of the masters 101 to 105 is any of a microprocessor, a DSP (digital signal processor), a DMA (direct memory access) controller, and the like. The shared resource 111 is any of a memory, a peripheral I/O controller, and the like. Note that the shared resource 111 is assumed to be a memory in the following description.

The access request arbitration section 100 arbitrates access conflict, depending on access requests from the five masters 101 to 105. Specifically, each of the masters 101 to 105 issues an access request to the access request arbitration section 100 as required in order to access the shared resource 111 for the purpose of data communication. The access request arbitration section 100 gives access permission to any of the five masters 101 to 105. One of the five masters 101 to 105 which receives the access permission issues a command to access the shared resource 111 via the queue input selector 112 to the command queue 106.

The command queue 106 successively receives and holds an access command 150 which has been issued from one of the masters 101 to 105 which is permitted to access and has been passed through the queue input selector 112, and issues one of access commands waiting for issuance to the resource control section 110 every time a command issuance request 151 is received from the resource control section 110.

The resource control section 110 gives the command issuance request 151 to the command queue 106 every time the shared resource 111 gets ready to access. Also, the resource control section 110 receives an access command 152 issued from the command queue 106 in response to the command issuance request 151, and in accordance with the received access command 152, controls data transfer between one of the five masters 101 to 105 and the shared resource 111. Note that these functions of the resource control section 110 may be possessed by the shared resource 111 itself.

FIG. 2 illustrates an exemplary format of the access command 150 given to the command queue 106 in FIG. 1. The access command 150 of FIG. 2 is composed of 40 bits. The least significant bit (bit 0) represents information (R/W) which designates one of read access and write access to the shared resource 111. A field composed of the next four bits (bits 4 to 1) represents information (ID) which identifies a master which has issued the access command 150. A field composed of the next four bits (bits 8 to 5) represents information (BEAT) which designates the number of beats of burst-mode access. A field composed of the next two bits (bits 10 and 9) represents information (SIZE) which designates an access size per beat, 1, 2, 4 or 8 bytes. A field composed of the next twenty-eight bits (bits 38 to 11) represents information (ADRS) which designates an access start address of the shared resource 111. The most significant bit (bit 39) represents information (D) which is used to inform that a data write operation to the shared resource 111 is completed. Note that the shared resource 111 of FIG. 1 is assumed to be divided into 256 memory spaces which are respectively designated with the 8 more significant bits of the 28-bit addresses. In other words, each memory space has a volume of 1 M bytes.

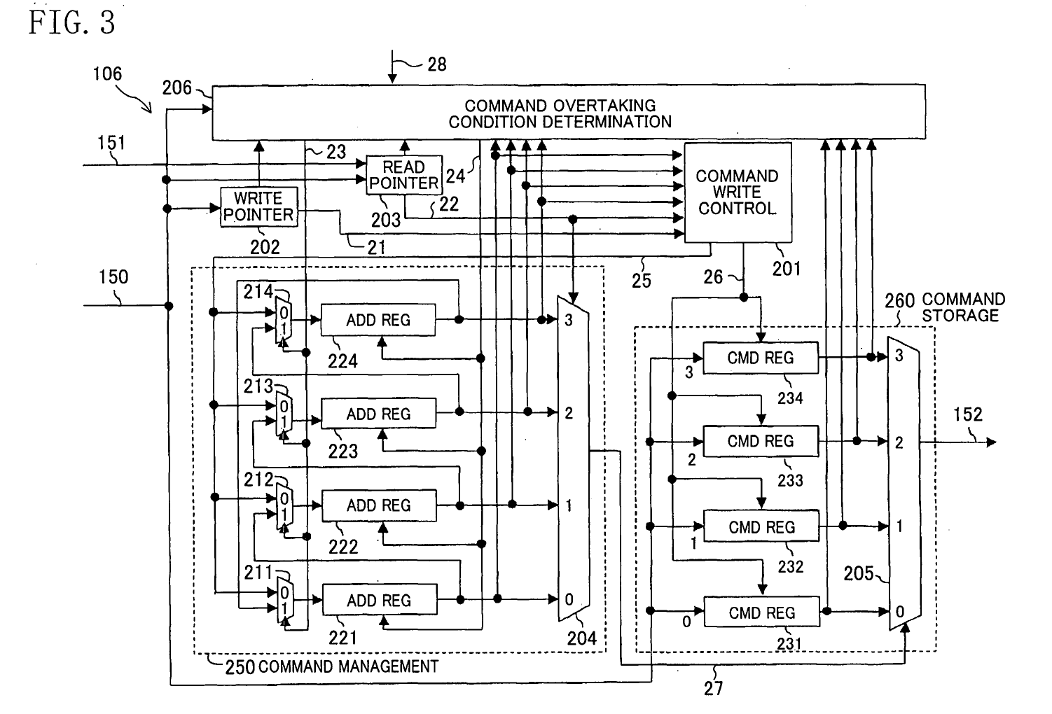

FIG. 3 illustrates an example of a detailed structure of the command queue 106 of FIG. 1. The command queue 106 of FIG. 3 comprises a command write control section 201, a write pointer 202, a read pointer 203, a command overtaking condition determination section 206, a command management section 250, and a command storage section 260. The command management section 250 comprises four address registers 221, 222, 223, 224, one address selector 204, and four register input selectors 211, 212, 213, 214. The command storage section 260 comprises four command registers 231, 232, 233, 234, and one command selector 205.

The four command registers 231 to 234 in the command storage section 260 are storage elements for holding the access command 150 received from any of the five masters 101 to 105, and are identified using respective register numbers 0, 1, 2, 3. Each of the command registers 231 to 234 receives a load/hold signal 26 from the command write control section 201. When the signal 26 designates “load”, the access command 150 is newly written. When the signal 26 designates “hold”, the currently held access command is held as it is. The command selector 205 selects one of the four command registers 231 to 234 in accordance with a register number signal 27 received from the command management section 250, and supplies the access command 152 read from the selected command register to the resource control section 110.

The four address registers 221 to 224 in the command management section 250 are storage elements for holding a register number which identifies a command register holding a valid access command among the four command registers 231 to 234. The four address registers 221 to 224 are identified with the register numbers 0, 1, 2, 3, respectively. The address selector 204 selects one of the four address registers 221 to 224 in accordance with a read address signal 22 provided from the read pointer 203, and supplies the register number signal 27 obtained from the selected address register to the command selector 205. In addition, the four address registers 221 to 224 are linked together via the four register input selectors 211 to 214 to construct a single circular queue. The command overtaking condition determination section 206 supplies a shift control signal 23 to each of the four register input selectors 211 to 214, and a load/hold signal 24 to each of the four address registers 221 to 224. A register number signal 25 to be newly written into any of the four address registers 221 to 224 is supplied from the command write control section 201. Each of the four register input selectors 211 to 214 selects an output of a corresponding one of the four address registers 221 to 224 when the shift control signal 23 indicates “1”, and the register number signal 25 supplied from the command write control section 201 when the shift control signal 23 indicates “0”.

The write pointer 202 is automatically incremented after a write address signal 21 which designates the number of one of the four address registers 221 to 224 into which the register number signal 25 is to be written when the command write control section 201 outputs the register number signal 25, is supplied to the command write control section 201 and the command overtaking condition determination section 206. When receiving the command issuance request 151, the read pointer 203 is automatically incremented after the read address signal 22 which designates the number of one of the four address registers 221 to 224 from which the register number signal 27 is to be read out in the next time, is supplied to the address selector 204, the command write control section 201 and the command overtaking condition determination section 206. The write pointer 202 and the read pointer 203 are incremented in a manner which allows the count to return to “0” after “3”, corresponding to a point where the address registers 221 to 224 constitute a circular queue. Note that a flag indicating a full/empty state of the circular queue is also provided, though it will not be explained.

The command write control section 201 performs a control so that the newly received access command 150 is held in an empty one of the four command registers 231 to 234. To achieve this, the command write control section 201 determines in which of the four address registers 221 to 224 a valid register number is held, based on the write address signal 21 and the read address signal 22, and based on the valid register number, determines which of the four command registers 231 to 234 is empty, and outputs the load/hold signal 26 to each of the four command registers 231 to 234 in a manner that allows one of the empty command register(s) to be designated as a load destination of the new access command 150. Further, the command write control section 201 outputs the signal 25 indicating the number of one of the four command registers 231 to 234 which is designated as the load destination of the access command 150, to the command management section 250.

The command overtaking condition determination section 206 controls the order of register numbers held in the four address registers 221 to 224 in accordance with a predetermined command overtaking condition set via, for example, a program input 28 so that all register numbers including a register number which identify one of the four command registers 231 to 234 which holds the newly received access command 150 and a register number identifying one of the four command registers 231 to 234 which holds a preceding access command are arranged in order of command issuance in the command management section 250. Therefore, the command overtaking condition determination section 206 receives the access command 150, the write address signal 21, the read address signal 22, outputs of the four address registers 221 to 224, and outputs of the four command registers 231 to 234. Based on these pieces of input information, the command overtaking condition determination section 206 determines the shift control signal 23 which is to be supplied to each of the four register input selectors 211 to 214 and the load/hold signal 24 which is to be supplied to each of the four address registers 221 to 224. For example, when the three address registers 221, 222, 223 hold the register numbers of preceding access commands and the new access command 150 is permitted to overtake the preceding access commands, the shift control signals 23 of “0”, “1”, “1” and “1” are supplied to the four register input selectors 211 to 214, respectively, and the load/hold signal 24 indicating “load” is supplied to all of the four address registers 221 to 224. Conversely, when overtaking is forbidden, the shift control signal 23 of “0” is supplied to the register input selector 214 and the load/hold signal 24 indicating “hold”, “hold”, “hold” and “load” are supplied to the four address registers 221 to 224, respectively.

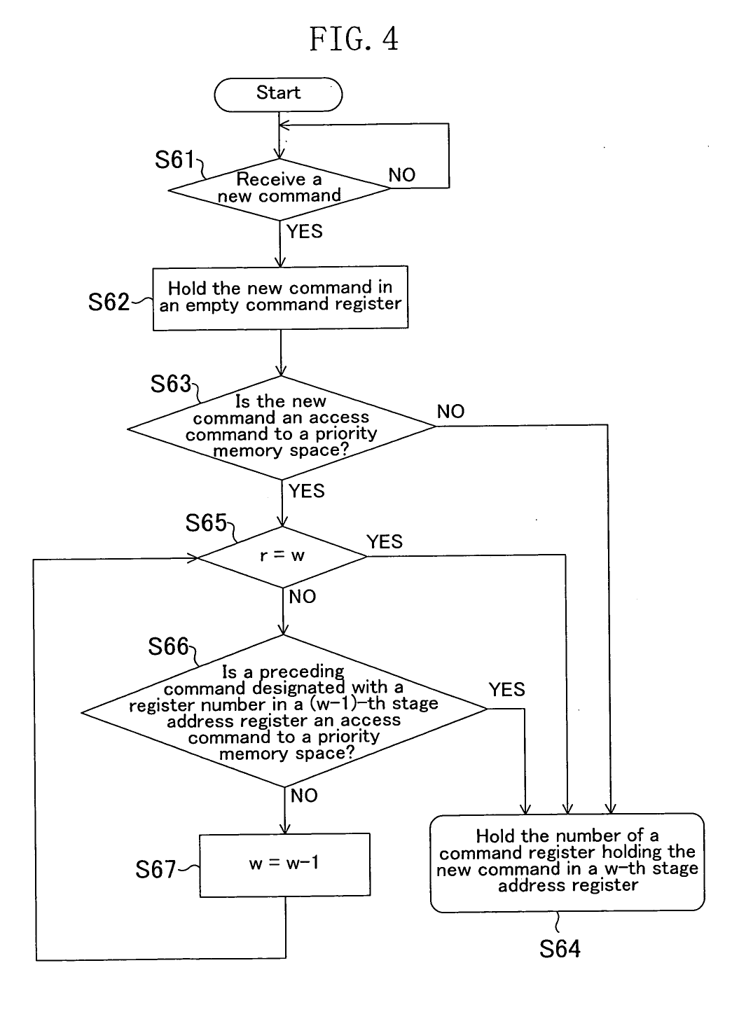

FIG. 4 illustrates an exemplary operation of the command write control section 201 and the command overtaking condition determination section 206 in FIG. 2. In this example, the command overtaking condition determination section 206 operates to determine whether or not the newly received access command 150 is an access command which requests access to a priority memory space in the shared resource 111, which is one of the command overtaking conditions. The priority memory space refers to one or a plurality of memory spaces requiring priority access of a total of 256 memory spaces in the shared resource 111. Each priority memory space is designated with information of 8 bits. Note that “w” represents a variable whose initial value is a register number indicated by the write address signal 21, and “r” is a constant which corresponds to a register number indicated by the read address signal 22.

According to FIG. 4, when the command queue 106 receives the new access command 150 in step S61, the command write control section 201 performs a control so that the access command 150 is held in an empty one of the four command registers 231 to 234 in step S62. In this case, the register number signal 25 which designates one of the four command registers 231 to 234 which holds the new access command 150 is output from the command write control section 201. Next, in step S63, the command overtaking condition determination section 206 determines whether or not the new access command 150 is a command to access the priority memory space, by comparing the priority memory space designation information held by the command overtaking condition determination section 206 with information in the ADRS field of the new access command 150. When the new access command 150 is not a command to access the priority memory space, the w-th stage address register of the four address registers 221 to 224 is caused to hold the register number signal 25 from the command write control section 201 in order to avoid overtaking in step S64. On the other hand, when the new access command 150 is a command to access the priority memory space, the variable w is compared with the constant r in step S65. In this case, when r=w, there is no access command waiting for issuance, and therefore, overtaking is not required, so that the process goes to step S64. Conversely, when r≠w, the command overtaking condition determination section 206 examines whether or not the immediately previous access command is a command to access the priority memory space, in step S66. The immediately previous access command is a preceding access command in a command register designated with a register number held in the (w−1)-th stage address register of the four address registers 221 to 224. When the preceding access command is a command to access the priority memory space, the process goes to step S64 in order to avoid overtaking. On the other hand, when the preceding access command is not a command to access the priority memory space, the new access command 150 is permitted to overtake the preceding access command, and therefore, the process returns to step S65 after the variable w is updated by decrement in step S67. In this case, the variable w is decremented in a manner which allows the count to return to “3” after “0”, corresponding to a point where the address registers 221 to 224 constitute a circular queue.

In step S65 again, when r=w, there is no preceding access command to be determined whether to be overtaken, the process goes to step S64, in which, based on the current variable w, the w-th stage address register of the four address registers 221 to 224 is caused to hold the register number signal 25 from the command write control section 201, and the register number of a preceding access command to be overtaken is shifted. In the next step S66, when it is determined that the immediately previous access command is a command to access the priority memory space, the process goes to step S64, in which a similar process is executed. In step S66, when it is determined that the immediately previous access command is not a command to access the priority memory space, the variable w is decremented in step S67 and the process returns to step S65.

Note that when a plurality of memory spaces are each designated as priority memory spaces, priority may vary among these priority memory spaces.

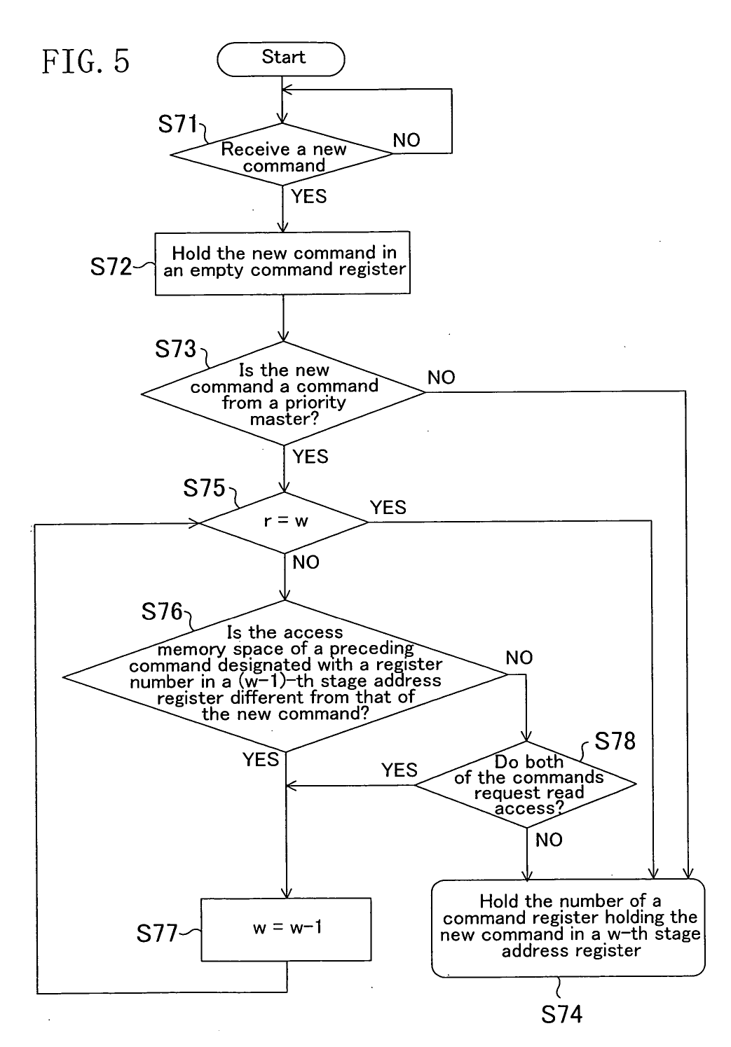

FIG. 5 illustrates another exemplary operation of the command write control section 201 and the command overtaking condition determination section 206 of FIG. 2. In this example, the command overtaking condition determination section 206 operates to determines whether or not the newly received access command 150 is an access command from one or a plurality of masters designated as priority master(s) of the five masters 101 to 105, which is one of the command overtaking conditions. It is also assumed that, when the new access command 150 and a preceding access command both request access to the same memory space and at least one of them requests write access, the new access command 150 is forbidden to overtake the preceding access command even if the new access command 150 is an access command from the priority master.

Processes in steps S71 and S72 of FIG. 5 are the same as those of steps S61 and S62 of FIG. 4, respectively. According to FIG. 5, in step S73, the command overtaking condition determination section 206 determines whether or not the new access command 150 is an access command from a priority master, by comparing priority master designation information held by the command overtaking condition determination section 206 with information in the ID field of the new access command 150. When the new access command 150 is not an access command from a priority master, the w-th stage address register of the four address registers 221 to 224 is caused to hold a register number designating one holding the new access command 150 of the four command registers 231 to 234 in order to avoid overtaking in step S74. On the other hand, when the new access command 150 is an access command from a priority master, the variable w is compared with the constant r in step S75. In this case, when r=w, there is no access command waiting for issuance, and therefore, overtaking is not required, so that the process goes to step S74. Conversely, when r≠w, the command overtaking condition determination section 206 examines whether or not a memory space to which the new access command 150 requests access is different from a memory space to which the immediately previous access command requests access in step S76. The immediately previous access command is a preceding access command in a command register designated with a register number held in the (w−1)-th stage address register of the four address registers 221 to 224. When both of the access commands request access to the same memory space, it is further examined in step S78 whether or not both of the access commands request read access. In this case, information (R/W) in the least significant bit of new access command 150 and corresponding information in the preceding access command are referenced. When both of the access commands request access to the same memory space and at least one of them requests write access, the process goes to step S74 in order to avoid overtaking. On the other hand, when both of the access commands request access to different memory spaces or both of the access commands request read access, the new access command 150 is permitted to overtake the preceding access command, and therefore, the process returns to step S75 after the variable w is decremented in step S77.

In step S75 again, when r=w, there is no preceding access command to be determined whether to be overtaken, the process goes to step S74, in which, based on the current variable w, the w-th stage address register of the four address registers 221 to 224 is caused to hold the register number signal 25 from the command write control section 201, and the register number of a preceding access command to be overtaken is shifted. In the next step S76 and S78, when it is determined that both the new access command 150 and the immediately previous access command request access to the same memory space and at least one of them requests write access, the process goes to step S74, in which a similar process is executed. On the other hand, when both of the access commands request access to different memory spaces or both of the access commands request read access, the process returns to step S75 after the variable w is decremented in step S77.

Note, when a plurality of masters are designated as priority masters, priority may vary among these priority masters. Also, determination in step S78 may be omitted so that when the new access command 150 and a preceding access command request access to the same memory space, command overtaking is certainly forbidden.

The number of the above-described masters is an arbitrary integer of 2 or more. The number of register stages in the command queue 160 is also an arbitrary integer of 2 or more.

As described above, the resource management apparatus of the present invention has a power consumption reducing effect or the like, and is particularly useful in a technique for causing a plurality of masters to share a resource.

What is claimed is:

1. In a system in which a plurality of masters access a shared resource, a resource management apparatus comprising:
an access request arbitration section of arbitrating access conflict, depending on access requests from the plurality of masters;
a command queue of successively receiving and holding an access command issued from any one of the plurality of masters which is permitted by the access request arbitration section to access, and issuing one of access commands waiting for issuance every time command issuance is requested; and
a resource control section of giving a command issuance request to the command queue and receiving an access command issued from the command queue, and in accordance with the received access command, controlling data transfer between one of the plurality of masters and the shared resource,
wherein the command queue comprises:
a plurality of first storage elements of each holding an access command received from any of the plurality of masters;
a plurality of second storage elements of each holding an address identifying one holding a valid access command of the plurality of first storage elements;
a command write control section of performing a control so that a newly received access command is held in an empty one of the plurality of first storage elements;
a command overtaking condition determination section of controlling an order of addresses held in the plurality of second storage elements in accordance with predetermined command overtaking conditions so that all addresses including an address identifying one holding the newly received access command of the plurality of first storage elements and an address identifying one holding a preceding access command of the plurality of first storage elements are arranged in order of command issuance; and
control means of performing a control so that an access command is read out from one identified with a leading address in the plurality of second storage elements of the plurality of first storage elements, and the read access command is supplied to the resource control section.

2. The resource management apparatus of claim 1, wherein
the command queue comprises:
a write pointer of designating one of the plurality of second storage elements to which an address is to be written in the next time; and
a read pointer of designating one of the plurality of second storage elements from which an address is to be read in the next time;
wherein the plurality of second storage elements are linked together to construct a circular queue.

3. The resource management apparatus of claim 1, wherein:
the shared resource is a memory; and
the access command received by the command queue includes information identifying one issuing the access command of the plurality of masters, information designating one of read access and write access to the memory, and an access address range of the memory.

4. The resource management apparatus of claim 1, wherein:
the shared resource is a memory; and
the command overtaking condition determination section operates to determine whether or not the newly received access command is an access command requesting access to a priority memory space in the memory, which is one of the command overtaking conditions.

5. The resource management apparatus of claim 1, wherein
the command overtaking condition determination section operates to determine whether or not the newly received access command is an access command issued one designated as a priority master of the plurality of masters, which is one of the command overtaking conditions.

6. The resource management apparatus of claim 1, wherein:
the shared resource is a memory; and
the command overtaking condition determination section operates to determine whether or not a memory space to which the newly received access command requests access is different from a memory space to which a preceding access command requests access, which is one of the command overtaking conditions.

7. The resource management apparatus of claim 1, wherein:
the shared resource is a memory; and
the command overtaking condition determination section operates to determine whether or not both the newly received access command and a preceding access command request read access, which is one of the command overtaking conditions.

8. The resource management apparatus of claim 1, wherein
the command overtaking condition determination section has a program input for setting the command overtaking condition.

9. In a system comprising a plurality of masters of accessing a shared resource for data communication, a command storage section having a plurality of registers of holding an access command received from the plurality of masters, and a command management section of holding a register number of the access command held in the command storage section, a resource management method for rearranging an issuing order of access commands from the plurality of masters to the shared resource, comprising:
a first step of receiving an access command from the plurality of masters and holding the received access command from the plurality of masters in an empty register of the command storage section;
a second step of determining whether or not the access command is an access command previously determined to be issued with priority;
a third step of, when a result of determination in the second step indicates that the access command is an access command to be issued with priority, determining whether or not there is an access command waiting for issuance;
a fourth step of, when a result of determination in the third step indicates that there is an access command waiting for issuance, determining whether or not the access command waiting for issuance is an access command to be issued with priority;
a fifth step of, when a result of determination in the fourth step indicates that the access command waiting for issuance is not an access command to be issued with priority, performing comparison for another access command waiting issuance; and
a sixth step of holding a register number of the access command in the command management section so that the access command is caused to be an access command to be issued after the compared access command, when a result of determination in the second step indicates that the access command is not an access command to be issued with priority, or when a result of determination in the third step indicates that there is no access command waiting for issuance, or when a result of determination in the fourth step indicates that the access command waiting for issuance is an access command to be issued with priority,
wherein, after the fifth step, the third to fifth steps are further repeated.

10. The method of claim 9, wherein
the access command to be issued with priority is an access command to a previously determined priority memory space.

11. The method of claim 9, wherein
the access command to be issued with priority is an access command from a previously determined priority master.
